(19) United States
(12) Patent Application Publication
(10) Pub. No.: US 2015/0142741 A1
(43) Pub. Date: May 21, 2015

(54) INFORMATION AGGREGATION FILE SYNCHRONIZING METHOD, DEVICE, AND SYSTEM

(71) Applicant: Tencent Technology (Shenzhen) Company Limited, Guangdong (CN)

(72) Inventors: Zhubin Jia, Guangdong (CN); Changwen Yuan, Guangdong (CN)

(73) Assignee: Tencent Technology (Shenzhen) Company Limited, Guangdong (CN)

(21) Appl. No.: 14/406,359

(22) PCT Filed: Jun. 9, 2013
(86) PCT No.: PCT/CN2013/077042

§ 371 Date: Dec. 8, 2014

(30) Foreign Application Priority Data
Jun. 11, 2012 (CN) 201210189978.8

(51) Int. Cl. G06F 17/30

(52) U.S. Cl. CPC G06F 17/30174; G06F 17/30106
USPC 707/634

(57) ABSTRACT

The present invention relates to an information syndication file synchronizing method, comprising: acquiring and saving the latest information publishing time in an information syndication file located on a first information publishing platform; acquiring the information syndication file, and comparing the latest publishing time with the publishing time of each piece of information in the acquired information syndication file; if the information publishing time is later than the latest publishing time, then searching for the information in a synchronization database; if searching in the synchronization database does not yield a match, then synchronizing the information onto a second information publishing platform for publishing, and saving the information to the synchronization database. The above method can efficiently synchronize an information syndication file without errors or omissions. Furthermore, also provided are an information syndication file synchronizing device and system.

### TECHNICAL FIELD

The present disclosure relates to a network communication field, and more particularly, to an information aggregation file synchronizing method, device, and system.

### BACKGROUND

Really Simple Syndication (RSS), also called aggregation content, is a type of format for describing and synchronizing website content. Nowadays, RSS is widely employed in network news channels, blogs, and wiki websites. Subscription based on RSS enables rapid obtainment of information, and RSS outputs provided by the website benefit the user to get the latest update of the website content.

Microblog, which is an information sharing, propagating, and obtaining platform based on user relations, has become an active user information and content sharing platform. The microblog system can rapidly improve blog exposure and further bring high-quality active users for the blog because of massive active users with the same interest in the microblog system.

However, the contents of the blog and the microblog are distributed in different platforms at present, this results in that the content of the blog cannot be synchronized to the microblog system and the user has to load the content of the blog to the microblog system continuously, thereby bringing many limitations to the user and degrading the service quality of the microblog.

### SUMMARY

In view of the above, it is necessary to provide an information aggregation file synchronizing method, device, and system for effectively synchronizing content published on one information publishing platform to other information publishing platforms.

The information aggregation file synchronizing method includes: obtaining and storing a latest information publishing time of an information aggregation file stored in a first information publishing platform; obtaining the information aggregation file and comparing a publishing time of each piece of information in the obtained information aggregation file with the latest information publishing time; searching for the piece of information in a synchronization database if the publishing time of the piece of information is later than the latest information publishing time; and synchronizing the piece of information to a second information publishing platform for publishing and storing the piece of information in the synchronization database, if there is no result matching the piece of information searched for in the synchronization database.

The information aggregation file synchronizing device includes: a publishing time obtaining unit configured for obtaining and storing a latest information publishing time of an information aggregation file stored in a first publishing platform; a time comparing unit configured for obtaining the information aggregation file and comparing a publishing time of each piece of information of the acquired information aggregation file with the latest information publishing time; a searching unit configured for searching for the piece of information in a synchronization database if the publishing time of the piece of information is later than the latest information publishing time; and a synchronizing unit configured for synchronizing the piece of information to a second information publishing platform for publishing and storing the piece of information to the synchronization database if there is no result matching the piece of information searched for in the synchronization database.

The information aggregation file synchronizing system includes a first information publishing platform configured for providing a first information service; a second information publishing platform configured for providing a second information service; a client configured for accessing the first information service and the second information service; a synchronizing device configured for synchronizing information of a information aggregation file stored in the first information publishing platform to the second information publishing platform for publishing, and a synchronization database configured for storing the synchronized information from the information aggregation file.

The information aggregation file synchronizing method, device, and system can conveniently synchronize the content of the first information publishing platform to the second information publishing platform. Additionally, by storing the synchronized items to the synchronization database, fields in addition to the publishing time can be used for searching when determining whether the information has been synchronized, thus avoiding an information mistake and omission caused by comparison based on the publishing time in the case where a number of items are published at the same time.

In order to make the characters and advantages of the invention apparent, some preferred embodiments are taken for example below to explain the invention with reference to the accompanying drawings.

### BRIEF DESCRIPTION OF THE DRAWINGS

FIG. 1 is a flowchart of an information aggregation file synchronizing method in accordance with a first embodiment of the present invention.

FIG. 2 is a flowchart of an information aggregation file synchronizing method in accordance with a second embodiment of the present invention.

FIG. 3 is a block diagram of an information aggregation file synchronizing device in accordance with a third embodiment of the present invention.

FIG. 4 is a block diagram of an information aggregation file synchronizing system in accordance with a fourth embodiment of the present invention.

### DETAILED DESCRIPTION OF THE PREFERRED EMBODIMENTS

For further illustrating the technical solutions and effects of the present disclosure, particular implementations, structures, features, and effects of an information aggregation file synchronizing method, device, and system in accordance with the present disclosure will be explained below in detail in conjunction with the accompanying drawings and preferred embodiments.

### A First Embodiment

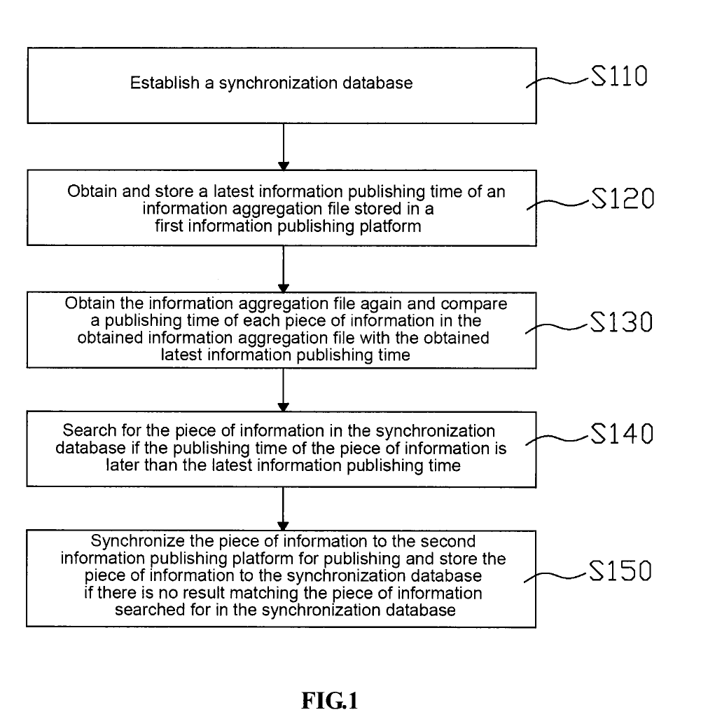

Referring to FIG. 1, the first embodiment provides an information aggregation file synchronizing method, which can be realized by a computer system and particularly includes steps below.

Step S110: establishing a synchronization database, where the synchronization database is configured for storing items which have been synchronized and also information that might be used in a synchronizing process. It should be understood that the synchronization database can be a universal database or a general file used for storage.

Step S120: obtaining and storing a latest information publishing time of an information aggregation file stored in a first information publishing platform. More specifically, Step 120 includes the following steps of: firstly receiving an address of a first information service submitted by a client, where the address of the first information service is provided by the first information publishing platform, and specifically may refer to for instance an address of a personal blog; analyzing the address of the first information service to extract a corresponding address of an RSS file, where generally there is a particular corresponding relation between the address of the RSS file and the address of the first information service according to the website design specification, therefore, the address of the RSS file can be obtained once the address of the first information service is obtained; downloading the RSS file from the first information publishing platform after the address of the RSS file is obtained; analyzing the downloaded RSS file to get the latest information publishing time of the RSS file (i.e. the content of a PubDate field of information updated at the latest); and then storing the latest information publishing time to the synchronization database.

Additionally, it should be understood that the latest information publishing time can be stored to the synchronization database or elsewhere.

Step S130: obtaining the information aggregation file again and comparing a publishing time of each piece of information in the obtained information aggregation file with the obtained latest information publishing time. Generally speaking, the RSS file is stored in a format similar to an Extensible Markup Language (XML) format. A set of all the information in the RSS file may be obtained from analyzing the RSS file. The information corresponds to for instance the content published by the user each time. Generally speaking, each piece of the information includes three fields, i.e. a publishing time field, a title field, and a content field. In the case of the RSS file in an XML format for example, each piece of information corresponds to one Item field of the RSS file according to a general specification, and the publishing time, title, and content of the piece of information respectively correspond to the contents of a PubDate field, a Title field, and a Description field of the Item field.

A piece of information is outputted each time in traversing the set of all the information, and the publishing time of the piece of information is compared with the latest information publishing time obtained in Step S120.

Step 140: searching for the piece of information in the synchronization database if the publishing time of the piece of information is later than the latest information publishing time. It should be understood that the publishing time of information published after Step S120 is later than the latest information publishing time obtained in step S120. Thus, the information published after Step S120 needs to be synchronized to the second information publishing platform. Each piece of the information published after Step S120 is searched for in the synchronization database. In the searching, the title or description of the information in addition to the publishing time can be used as a searching key word. Only when the matching title or description is additionally found, a result matching the piece of information may be got. If no result matching the piece of information is got, it is indicated that this piece of information has not been synchronized to the second information publishing platform.

Step S150: synchronizing the piece of information to the second information publishing platform for publishing and storing the piece of information to the synchronization database if there is no result matching the piece of information searched for in the synchronization database. The synchronizing process can be realized by calling an application programming interface (API) opened in the second information publishing platform, specifically, for example, calling the API can be realized by initialing an API calling request to the second information publishing platform and accomplishing authentication of the user in the second information publishing platform; or calling the API can be realized by storing user identification information such as a user name and a password and initialing the API calling request to the second publishing platform according to the user identification information. Then, the information to be synchronized is published on the second information publishing platform by using the API.

It should be understood that due to the fact that requirements for the published content vary with different information publishing platforms, for example the number of characters in a microblog is limited, the format of the content of other publishing platforms should be formatted to satisfy the requirement of the microblog before synchronizing the information of other publishing platforms to the microblog. It is the like case for platforms other than the microblog. After the information is synchronized, the synchronized information can be stored to the synchronization database to be subsequently compared in the following synchronizing operation.

When storing the information to the synchronizing database, besides the publishing time of the information, at least one of the title field and the description field of the information is stored to the synchronizing database, namely, at least the fields used to search for the matching piece of information at Step S140 is stored to the synchronizing database.

In the above described steps, Step S110 needs to be performed for only one time, Steps S120 to S150 can be repeated. It should be understood that Step 120 can be performed after Step S150.

In the information aggregation file synchronizing method of the present embodiment, the content of the first information publishing platform can be easily synchronized to the second information publishing platform. Additionally, by storing the synchronized information to the synchronization database, fields in addition to the publishing time can be used for searching when determining whether the information has been synchronized, thus avoiding an information mistake and omission caused by comparison based on only the publishing time in the case where a number of items are published at the same time in the RSS file.

### A Second Embodiment

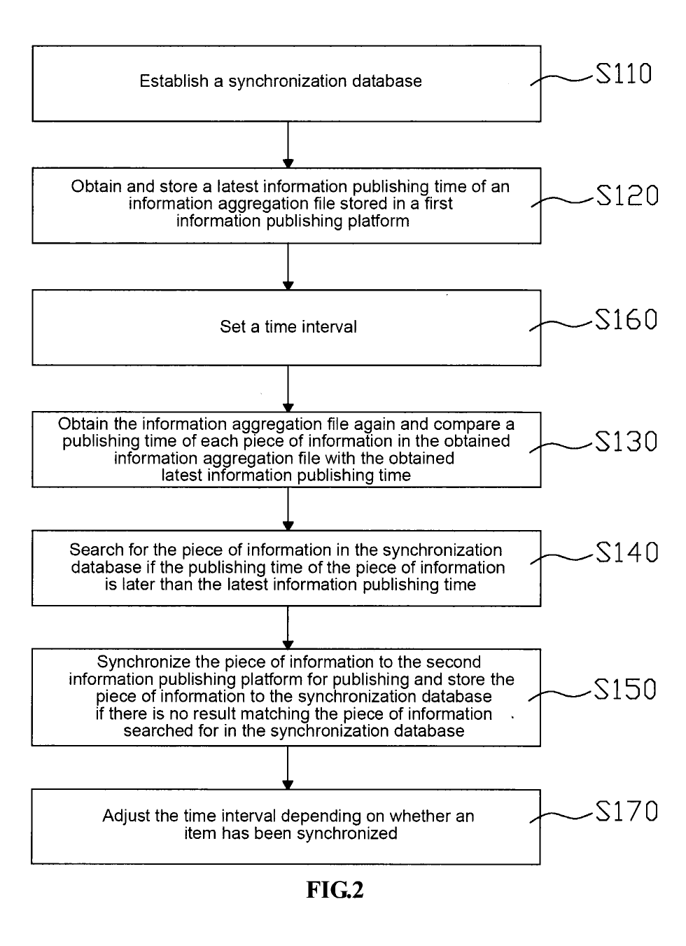

Referring to FIG. 2, the second embodiment provides an information aggregation file synchronizing method which is similar to the information aggregation file synchronizing method of the first embodiment, except for a difference in that: after Step S150, the method of the second embodiment further includes:

Step S160: setting a time interval between Step S120 and Step S130, and

Step S170: adjusting the time interval depending whether an item is synchronized in Step S150.

Specifically, if an item is synchronized to the second information publishing platform in Step S150, it is shown that the user has updated the information in the first information publishing platform during the time interval between Steps S120 and S130 and the user is very active. In order to ensure the content published by the highly active user can be synchronized in time, an algorithm for the time interval can be updated to shorten the time interval.

On the contrary, if no item is synchronized in Step S150, it is shown that the user is inactive, and the algorithm for the time interval can be updated to prolong the time interval to reduce the system resource waste by the inactive user.

Additionally, the implementing of Steps S120 to S170 may be effected by various factors such as network and server loads, causing failed implementations of these steps. It should be understood that these failures are caused by the system per se, and should be corrected in time. Generally, performing the failed steps again or performing the synchronizing operation again can correct the failures. Performing the synchronizing operation again refers to for instance performing Steps S120 to S160 again, namely the steps except for the step of establishing the synchronization database in the information aggregation file synchronizing method of the present embodiment.

However, if performing the failed steps or synchronizing operation again when the failures are caused by the excessive load of the system, the load of the system will be increased, thus the processing ability of the system will be further degraded, and such vicious circle results in a domino effect. At this time, the synchronizing operation can be delayed for a predetermined time period, which degrades the service within the tolerance of the user.

In the information aggregation file synchronizing method of the present embodiment, the adjustment of the time interval between Step S120 and Step 130 can not only ensure the information published by the active user can be synchronized in time, also can avoid the system resource waste by the inactive user.

### A Third Embodiment

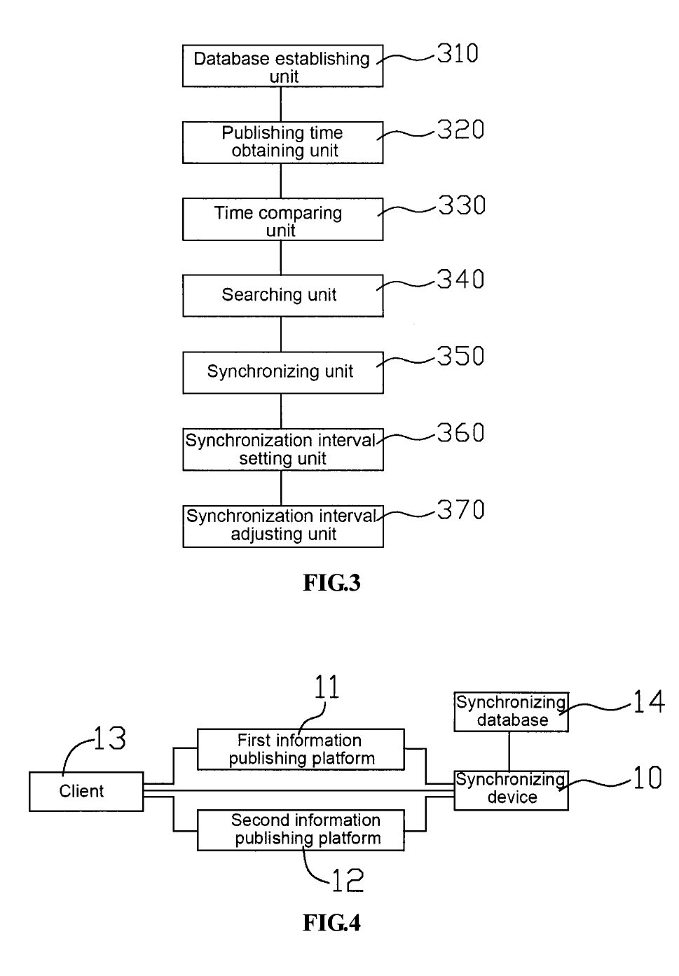

Referring to FIG. 3, the third embodiment provides an information aggregation file synchronizing device including a database establishing unit 310, a publishing time obtaining unit 320, a time comparing unit 330, a searching unit 340, and a synchronizing unit 350.

The database establishing unit 310 is configured for establishing a synchronization database. The publishing time obtaining unit 320 is configured for obtaining and storing a latest information publishing time of an information aggregation file stored in a first publishing platform. The time comparing unit 330 is configured for obtaining the information aggregation file and comparing a publishing time of each piece of information in the obtained information aggregation file with the latest information publishing time. The searching unit 340 is configured for searching for a piece of information in the synchronization database if the publishing time of the piece of information is later than the latest information publishing time. The synchronizing unit 350 is configured for synchronizing the piece of information to a second information publishing platform for publishing and storing the piece of information to the synchronization database if there is no result matching the piece of information searched for in the synchronization database.

Specifically, the publishing time obtaining unit 320 is further configured for: receiving an address of a first information service submitted by a client; analyzing the address of the first information service to extract an address of the information aggregation file; downloading the information aggregation file based on the address of the information aggregation file; analyzing the downloaded information aggregation file to get the latest information publishing time; and storing the latest information publishing time to the synchronization database.

Additionally, the synchronizing device further includes a synchronization interval setting unit 360 and a synchronization interval adjusting unit 370. The synchronization interval setting unit 360 is configured for setting a time interval between the actuation of the publishing time obtaining unit and the actuation of the time comparing unit. The synchronization interval adjusting unit 370 is configured for adjusting the time interval set by the synchronization interval setting unit 360. Specifically, the time interval is shortened after the synchronizing unit 350 synchronizes the information to the second information publishing platform and the time interval is prolonged if no information is synchronized to the second information publishing platform in one synchronizing operation.

The operations of the publishing time obtaining unit 320, the time comparing unit 330, the searching unit 340, the synchronizing unit 350, and the synchronization interval setting unit 370 might be effected by various factors such as network and server loads, causing failed operations of these units. It should be understood that these failures are caused by the system per se, and should be corrected in time. Generally, starting the failed units again or performing the synchronizing operation again, namely starting all the units again, can correct the failures. However, if starting the failed steps or synchronizing operation again when the failures are caused by the excessive load of the system, the load of the system will be increased, thus the processing ability of the system will be further degraded, and such vicious circle results in a domino effect. At this time, the synchronizing operation can be delayed for a predetermined time period, which degrades the service within the tolerance of the user.

For the detailed description of the publishing time obtaining unit 320, the time comparing unit 330, the searching unit 340, the synchronizing unit 350, the synchronization interval setting unit 360, and the synchronization interval adjusting unit 370, reference may be made to FIGS. 1 and 2 and related description.

In the information aggregation file synchronizing device of the present embodiment, by storing the synchronized information to the synchronization database, the fields in addition to the publishing time can be used for searching when determining whether the information has been synchronized, thus avoiding an information mistake and omission caused by comparison based on only the publishing time in the case where a number of items are published at the same time.

### A Fourth Embodiment

Referring to FIG. 4, the fourth embodiment provides an information aggregation file synchronizing system including a synchronizing device 10, a first information publishing platform 11, a second information publishing platform 12, a client 13, and a synchronizing database 14.

The synchronizing device 10, the first information publishing platform 11, and the second information publishing platform 12 may be for instance server systems. The first information publishing platform 11 provides the first information service. Specifically, the first information publishing platform 11 can be for instance a blog platform for providing a blog service for users. The second information publishing platform 12 provides a second information service. Specifically, the second information publishing platform 12 is for instance a microblog platform providing a microblog service for users. The client 13 is a user terminal used by the user and allows the user to access the synchronizing device 10, the first information publishing platform 11, and the second information publishing platform 12. Specifically, the client 13 may be for instance a desktop computer, a notebook computer, a tablet computer, or a smartphone. The synchronizing database 14 is configured for storing information that has been synchronized to the second information publishing platform by the synchronizing device 10, so that the information is available for searching when the synchronizing device 10 implements the synchronizing operation again.

The synchronizing device 10 is the synchronizing device illustrated in the third embodiment, and reference may be further made to FIG. 3 and related description. Additionally, the synchronizing device 10 also can be integrated with the first information publishing platform 11 to act as a function module of the first information publishing platform 11.

In the information aggregation file synchronizing system of the present embodiment, by storing the synchronized information to the synchronization database, the fields in addition to the publishing time can be used for searching when determining whether the information has been synchronized, thus avoiding an information mistake and omission caused by comparison based on only the publishing time in the case where a number of items are published at the same time.

Additionally, an embodiment of the present invention provides a computer readable storage medium with computer executable instructions stored therein. The computer readable storage medium may be a non-volatile memory such as an compact disc, a hard disk, or a flash memory. The computer executable instructions include:

an instruction for establishing a synchronization database;

an instruction for obtaining and storing a latest information publishing time of an information aggregation file stored in a first information publishing platform;

an instruction for obtaining the information aggregation file and comparing a publishing time of each piece of information in the obtained information aggregation file with the latest information publishing time;

an instruction for searching for a piece of information in a synchronization database if the publishing time of the piece of information is later than the latest information publishing time; and

an instructions for synchronizing the piece of information to a second information publishing platform for publishing and an instruction for storing the piece of information to the synchronization database if there is no result matching the piece of information searched for in the synchronization database.

Further, the instruction for obtaining and storing a latest information publishing time of an information aggregation file stored in a first information publishing platform further includes:

an instruction for receiving an address of a first information service submitted by a client;

an instruction for analyzing the address of the first information service to extract an address of the information aggregation file;

an instruction for downloading the information aggregation file based on the address of the information aggregation file;

an instruction for analyzing the downloaded information aggregation file to get the latest information publishing time; and

an instruction for storing the latest information publishing time to the synchronization database.

Further, the computer executable instructions include an instruction for separating the execution of the instruction for obtaining and storing a latest information publishing time of an information aggregation file stored in a first information publishing platform from the instruction for obtaining the information aggregation file and comparing a publishing time of each piece of information in the obtained information aggregation file with the latest information publishing time by a time interval.

Further, the computer executable instructions further include an instruction for prolonging the time interval if no item is synchronized to the second information publishing platform.

Further, the computer executable instructions further include an error handling instruction for, if the executing of the above instruction fails, executing the failed instruction again.

Further, the computer executable instructions further include an error handling instruction for, if the execution of the above instruction fails, executing all instructions again.

Further, the computer executable instructions further include an error handling instruction for, if the execution of the above instruction fails, executing all instructions again after a predetermined time period.

The above description are some exemplary embodiments of the invention and not intend to do any formal limitation to the invention. The preferred embodiments described as above for disclosing the invention should not be regarded as limitations to the invention. A person having ordinary skills in the art can make improvements and modifications to the embodiments in light of the above technical disclosures within the scope of the invention. The improvements and modifications made without departing from the scope of the invention fall within the scope of the invention.

What is claimed is:

1. An information aggregation file synchronizing method, comprising steps of:
obtaining and storing a latest information publishing time of an information aggregation file stored in a first information publishing platform;
obtaining the information aggregation file and comparing a publishing time of each piece of information in the obtained information aggregation file with the latest information publishing time;
searching for the piece of information in a synchronization database if the publishing time of the piece of information is later than the latest information publishing time; and
synchronizing the piece of information to a second information publishing platform for publishing, and storing the piece of information in the synchronization database, if there is no result matching the piece of information searched for in the synchronization database.

2. The information aggregation file synchronizing method of claim 1, wherein the step of obtaining and storing a latest information publishing time of an information aggregation file stored in a first information publishing platform comprises:
receiving an address of a first information service submitted by a client;
analyzing the address of the first information service to extract an address of the information aggregation file;
downloading the information aggregation file based on the address of the information aggregation file;
analyzing the downloaded information aggregation file to get the latest information publishing time; and
storing the latest information publishing time to the synchronization database.

3. The information aggregation file synchronizing method of claim 1, further comprising setting a time interval between the obtaining and storing the latest information publishing time of an information aggregation file stored in the first information publishing platform and the obtaining the information aggregation file.

4. The information aggregation file synchronizing method of claim 3, further comprising:
shortening the time interval if the piece of information is synchronized to the second information publishing platform for publishing, and
prolonging the time interval if no information is synchronized to the second information publishing platform for publishing.

5. The information aggregation file synchronizing method of claim 1, if execution of at least one of the steps of the method fails, further comprising:
executing the failed step again instantly; or
executing all the steps again instantly; or
executing all the steps again after delaying for a predetermined time.

6. An information aggregation file synchronizing device, comprising:
a publishing time obtaining unit configured for obtaining and storing a latest information publishing time of an information aggregation file stored in a first publishing platform;
a time comparing unit configured for obtaining the information aggregation file and comparing a publishing time of each piece of information in the obtained information aggregation file with the latest information publishing time;
a searching unit configured for searching for the piece of information in a synchronization database if the publishing time of the piece of information is later than the latest information publishing time; and
a synchronizing unit configured for synchronizing the piece of information to a second information publishing platform for publishing and storing the piece of information to the synchronization database if there is no result matching the piece of information searched for in the synchronization database.

7. The information aggregation file synchronizing device of claim 6, wherein the publishing time obtaining unit is further configured for:
receiving an address of a first information service submitted by a client;
analyzing the address of the first information service to extract an address of the information aggregation file;
downloading the information aggregation file based on the address of the information aggregation file;
analyzing the downloaded information aggregation file to get the latest information publishing time; and
storing the latest information publishing time to the synchronization database.

8. The information aggregation file synchronizing device of claim 6, further comprising a synchronization interval setting unit configured for setting a time interval between the actuation of the publishing time obtaining unit and the actuation of the time comparing unit.

9. The information aggregation file synchronizing device of claim 8, further comprising a synchronization interval adjusting unit configured for:
if no information is synchronized to the second information publishing platform during a synchronization process by the synchronizing unit, prolonging the time interval; otherwise, shortening the time interval.

10. The information aggregation file synchronizing device of claim 6, wherein if an operation of at least one of the publishing time obtaining unit, the time comparing unit, the searching unit, and the synchronizing unit fails, the operation of the failed unit is executed again instantly.

11. The information aggregation file synchronizing device of claim 6, wherein if an operation of at least one of the publishing time obtaining unit, the time comparing unit, the searching unit, and the synchronizing unit fails, operations of all the units are executed again.

12. The information aggregation file synchronizing device of claim 6, if an operation of at least one of the publishing time obtaining unit, the time comparing unit, the searching unit, and the synchronizing unit fails, operations of all the units are executed again after delaying for a predetermined time period.

13. An information aggregation file synchronizing system, comprising:
a first information publishing platform configured for providing a first information service;
a second information publishing platform configured for providing a second information service;
a client configured for accessing the first information service and the second information service;
a synchronizing device configured for synchronizing information of a information aggregation file stored in the first information publishing platform to the second information publishing platform for publishing, and
a synchronization database configured for storing the synchronized information from the information aggregation file;
wherein the synchronizing device is a device of claim 6.

14. (canceled)

15. (canceled)

16. (canceled)

17. (canceled)

18. (canceled)
